(19) United States
(12) Patent Application Publication
(10) Pub. No.: US 2018/0013112 A1
(43) Pub. Date: Jan. 11, 2018

(54) Automobile Engine Starter Power Supply Box Structure

(71) Applicant: Boonyong Cameron, Nonthaburi (TH)

(72) Inventor: Boonyong Cameron, Nonthaburi (TH)

(21) Appl. No.: 15/284,225

(22) Filed: Oct. 3, 2016

(30) Foreign Application Priority Data
Oct. 2, 2015 (TH) 1501006114

(51) Int. Cl. H01M 2/10; H01M 10/0525; F02N 11/08; H01M 10/06; H01M 10/30

(52) U.S. Cl. CPC H01M 2/1077; H01M 10/06; H01M 10/30; F02N 11/0866; H01M 10/0525; H01M 2220/20

(57) ABSTRACT

The automobile engine starter power supply box structure, which was designed in the right height and width for installation in place of the current automobile or motorcycle battery has the following special features one of the positions of the automobile engine starter power supply box structure has at least one space for the placement of rechargeable batteries in which removable rechargeable batteries can be placed, at a space of the automobile engine starter power supply box structure is a cap functioning to close and push the rechargeable batteries for firm mounting with the system.

### CROSS-REFERENCE TO RELATED APPLICATIONS

The present application is filed, and claims the benefit of and full Paris Convention priority of Thailand Patent Application No. 1501006114, filed on Oct. 2, 2015. The entire contents of this Thailand patent application is incorporated herein by reference.

### BACKGROUND OF THE INVENTION

The invention relates generally to technology involved with automobile engine starter power supply box structure.

The prior art discloses the use of an automobile engine starter power supply equipment in which at least one 5-10-amp rechargeable battery transfers power to the super capacitor; at least one super capacitor stores electricity as an energy source for starting automobile engines and at least one balancer is composed of a diode and an LED light bulb. The diode functions to send electricity to every super capacitor and the LED light bulb functions to show whether or not every super capacitor has a full, steady, equal flow of electricity. Further, the rechargeable batteries are connected to the super capacitor whereby multiple super capacitors are mounted in a series or mounted in parallel as a single power supply set. Each super capacitor is connected to a balancer which performs the function of transmitting electrical currents to every super capacitor and shows whether or not each super capacitor mounted in a series as a single power supply set is fully and equally loaded. The multiple super capacitors can rapidly release energy together within a short period of time in order to start the automobile engine.

The aforementioned automobile engine starter power supply equipment can start every type of automobile engine without limitations to certain types of automobiles and motorcycles. The prior art does not have the designed automobile engine starter power supply box structure to support the removable rechargeable batteries and installation in place of current automobile or motorcycle batteries.

Thus, there is a need for a structure of a box designed to encase automobile engine starter power supply equipment that has the right height and width for installation in place of current automobile or motorcycle batteries.

### SUMMARY OF THE INVENTION

An automobile engine starter power supply box structure designed in the right height and width for installation for an automobile or motorcycle battery that has the following special features: One of the positions of the automobile engine starter power supply box structure has at least one space for the placement of rechargeable batteries in which removable rechargeable batteries can be placed. At a space of the automobile engine starter power supply box structure is a cap functioning to close and push the rechargeable batteries, for firm mounting with the system.

### BRIEF DESCRIPTION OF THE DRAWINGS

FIG. 1 shows the automobile engine starter power supply box structure and internal components with cap open.

FIG. 2 shows the automobile engine starter power supply box structure and internal components with cap closed.

FIG. 3 shows an exploded view of the different components of the automobile engine starter power supply box structure, including alkaline batteries.

FIG. 4 shows rechargeable batteries that are lithium iron or lithium phosphate, or nickel metal hydride, or lead-acid batteries in the automobile engine starter power supply box with cap open.

FIG. 5 shows rechargeable batteries that are lithium iron or lithium phosphate, or nickel metal hydride, or lead-acid batteries in the automobile engine starter power supply box with cap closed.

FIG. 6 shows an exploded view of the different components of the automobile engine starter power supply box structure, including lithium batteries.

### DETAILED DESCRIPTION OF THE INVENTION

The present disclosure provides for an automobile engine starter power supply box structure comprising rechargeable batteries wherein the rechargeable batteries may be at least one of the following: either double-A (AA) or triple-A (AAA) alkaline batteries, or 18650A, or C size, D size batteries; Further, the rechargeable batteries may also be at least one of the following: either double-A (AA) or triple-A (AAA) alkaline batteries, or 18650A, or C size, D size batteries in a mounted series or parallel series to serve as a single power supply set. Additionally, the rechargeable batteries may also be lithium iron, lithium phosphate, nickel metal hydride or lead-acid batteries.

One of the positions of the automobile engine starter power supply box structure has at least one space for the placement of rechargeable batteries in which removable rechargeable batteries can be placed, because rechargeable batteries have a limited usage life that differs from super capacitors and balancers with a long usage life and ability to start engines more than a hundred thousand times.

At a space of the automobile engine starter power supply box structure is a cap functioning to close and push the rechargeable batteries, for firm mounting with the system. A part of the aforementioned are positive and negative battery terminals connected to the system in order to handle the mounting of the automobile or motorcycle starter system to start in the same way as current batteries.

The structure of the automobile engine starter power supply equipment box, which was designed in the right height and width for installation in place of the present automobile or motorcycle battery, has the following special features: An automobile engine starter power supply box structure comprising rechargeable batteries wherein the wherein the rechargeable batteries may be at least one of the following: rechargeable batteries composed of at least one of the following: either double-A (AA) or triple-A (AAA) alkaline batteries, or 18650A, or C size, D size batteries; rechargeable batteries composed of at least one of the following: either double-A (AA) or triple-A (AAA) alkaline batteries, or 18650A, or C size, D size batteries in a mounted series or parallel series to serve as a single power supply set; or rechargeable batteries that are lithium iron, or lithium phosphate, or nickel metal hydride, or lead-acid batteries.

One of the positions of the automobile engine starter power supply box structure has at least one space for the placement of rechargeable batteries in which removable rechargeable batteries can be placed, because rechargeable batteries have a limited usage life that differs from super capacitors and balancers with a long usage life and ability to start engines more than a hundred thousand times.

At a space of the automobile engine starter power supply box structure is a cap functioning to close and push the rechargeable batteries, for firm mounting with the system. A part of the aforementioned are positive and negative battery terminals connected to the system in order to handle the mounting of the automobile or motorcycle starter system to start in the same way as current batteries.

This invention is aimed at enabling the use of an automobile engine starter power supply box structure using rechargeable batteries with less power and size than previous lead-acid batteries and much less toxicity for the environment when compared to previous lead-acid batteries. The invention has a long usage life with the ability to start an engine more than a hundred thousand times. It is also lighter weight than lead-acid batteries by one of the positions of the automobile engine starter power supply box structure has at least one space for the placement of rechargeable batteries in which removable rechargeable batteries can be placed.

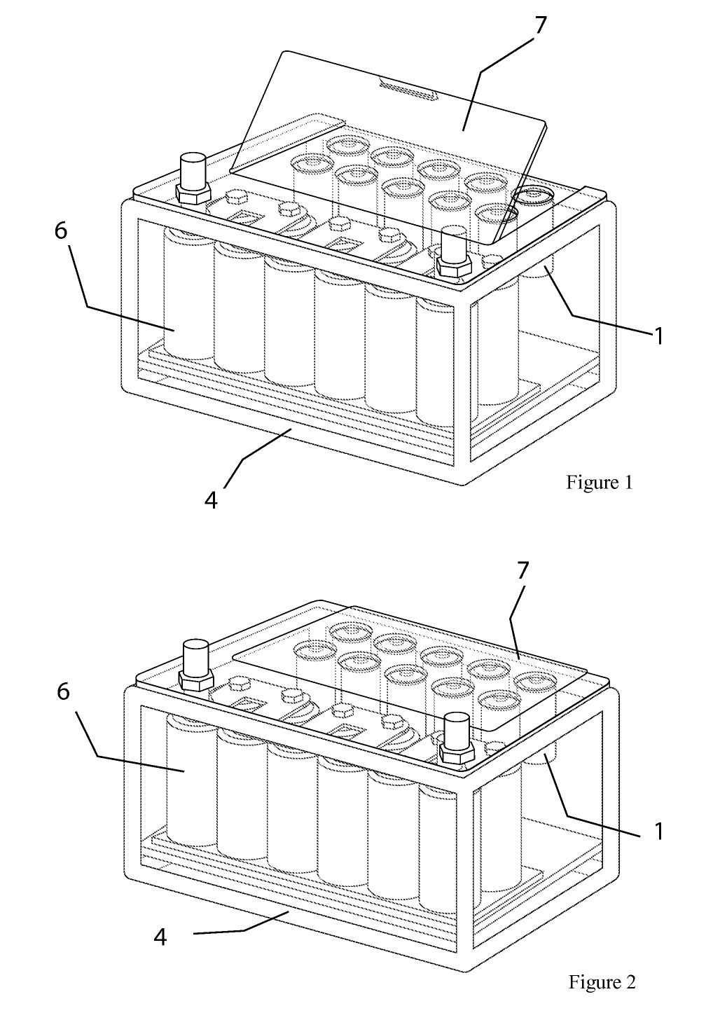

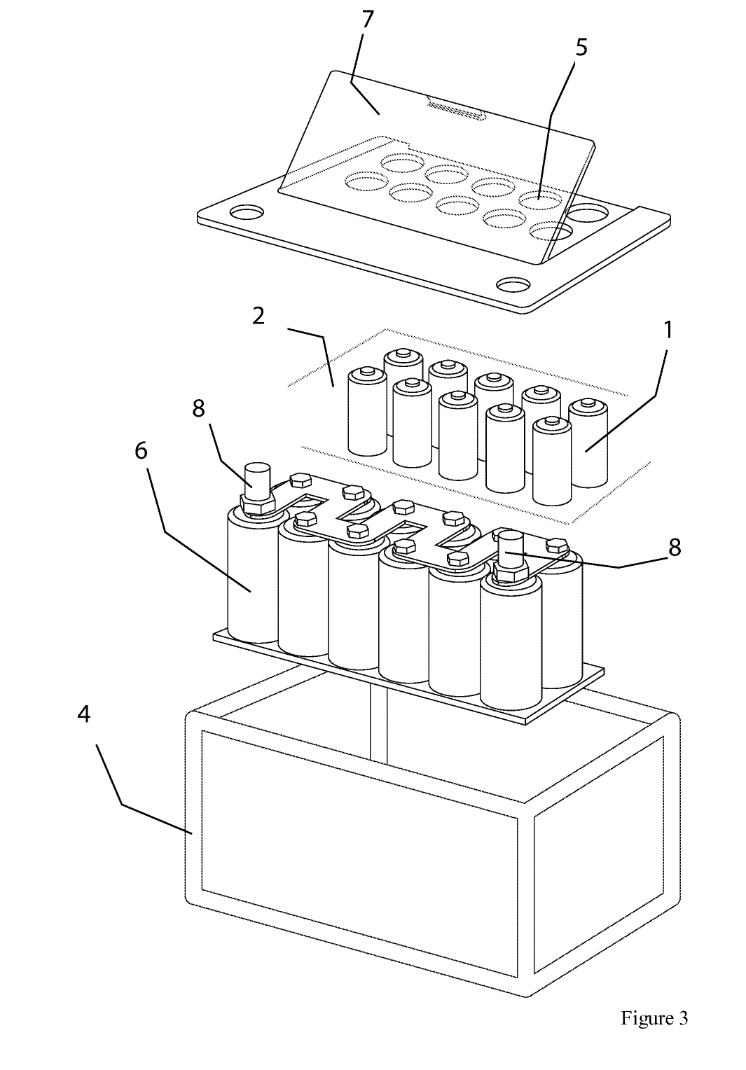

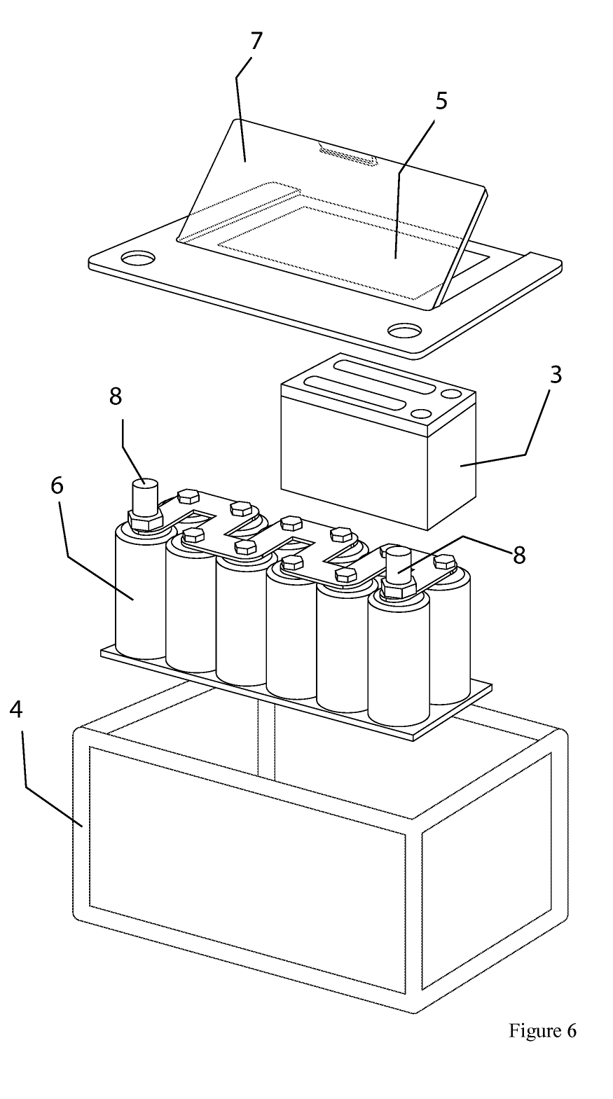

Referring to FIG. 1-6, an automobile engine starter power supply box structure 4 is shown, which was designed in the right height and width for installation in place of the current automobile or motorcycle battery has the special features described below. As shown in FIG. 1-3 rechargeable batteries 1 comprise at least one of the following: either double-A (AA) or triple-A (AAA) alkaline batteries, or 18650A, or C size, D size batteries in the automobile engine starter power supply box 4.

Referring to FIGS. 1-3, rechargeable batteries 2 comprise at least one of the following: either double-A (AA) or triple-A (AAA) alkaline batteries, or 18650A, or C size, D size batteries in a mounted series or parallel series to serve as a single power supply set in the automobile engine starter power supply box 4.

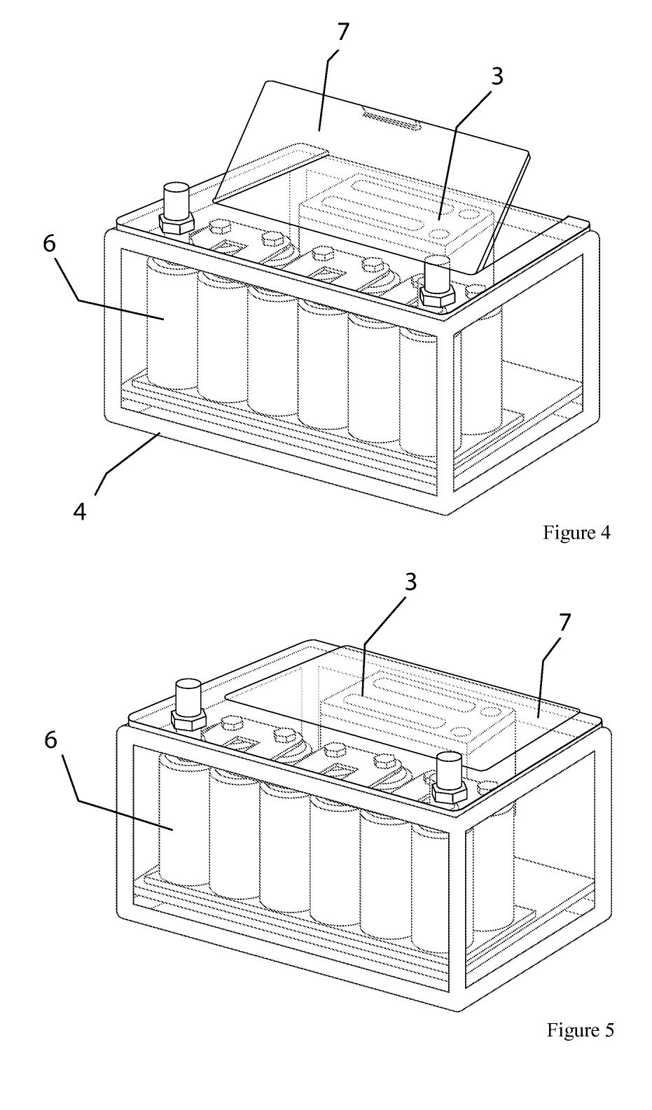

FIG. 4-6 show rechargeable batteries 3 that are lithium iron, or lithium phosphate, or nickel metal hydride, or lead-acid batteries in the automobile engine starter power supply box 4.

One of the positions of the automobile engine starter power supply box structure 4 has at least one space for the placement of rechargeable batteries 5 in which removable rechargeable batteries can be placed, because rechargeable batteries have a limited usage life that differs from super capacitors 6 and balancers with a long usage life and ability to start engines more than a hundred thousand times.

At a space of the automobile engine starter power supply box structure 4 is a cap functioning 7 to close and push the rechargeable batteries, for firm mounting with the system. A part of the Automobile engine starter power supply box structure 4 are positive and negative battery terminals 8 connected to the system in order to handle the mounting of the automobile or motorcycle starter system to start in the same way as current batteries.

We claim:

1. An automobile engine starter power supply box, comprising:
a top panel, a bottom panel, and four side panels, wherein two of the side panels are longer than the other two side panels and wherein the top panel includes a plurality of openings;
at least one space in the power supply box for the placement of a plurality of rechargeable batteries; and
a cap on the top panel to close and push at least a portion of the rechargeable batteries.
The automobile engine starter power supply box of claim 1, wherein the rechargeable batteries are selected from the group consisting of: double-A batteries alkaline batteries, triple-A alkaline batteries, 18650A batteries or C batteries or D batteries.

3. The automobile engine starter power supply box of claim 1, wherein the rechargeable batteries are selected from the group consisting of: double-A batteries alkaline batteries, triple-A alkaline batteries, 18650A batteries or C batteries or D batteries in a mounted series or parallel series to serve as a single power supply set.

4. The automobile engine starter power supply box of claim 1, herein the rechargeable batteries that are selected from the group consisting of: lithium iron, lithium phosphate, nickel metal hydride, or lead-acid batteries.
